(19) United States
(12) Patent Application Publication
(10) Pub. No.: US 2020/0003675 A1
(43) Pub. Date: Jan. 2, 2020

(54) INCREMENTAL TIME LAPSE DETECTION OF CORROSION IN WELL CASINGS

(71) Applicant: Halliburton Energy Services, Inc., Houston, TX (US)

(72) Inventors: Burkay Donderici, Pasadena, CA (US); Aixa Maria Rivera-Rios, Houston, TX (US); Luis Emilio San Martin, Albuquerque, NM (US); Luis F. Quintero, Katy, TX (US)

(21) Appl. No.: 16/465,436

(22) PCT Filed: Feb. 22, 2017
(86) PCT No.: PCT/US2017/018946

§ 371 Date: May 30, 2019

(51) Int. Cl. G01N 17/04; E21B 47/00

(52) U.S. Cl. CPC G01N 17/04; E21B 47/00

(57) ABSTRACT

Apparatus and methods to investigate a multiple nested conductive pipe structure can be implemented in a variety of applications. A pipe characterization tool obtains first measurements of multiple nested conductive pipes at a first time subsequent to placement of at least one of the multiple nested conductive pipes in a wellbore, and at a second time subsequent to the first time. Processing circuitry calculates a thickness change of the multiple nested conductive pipes between the first time and the second time and predicts future thickness based on this thickness change. Well treatment decisions can be made based on predicted future thickness. Additional apparatus, systems, and methods are disclosed.

### BACKGROUND

Early detection of corrosion in well casings is crucial to ensure the integrity and the safety of the well. State-of-the-art methods for downhole corrosion detection do not take into account the state of the well casings at the time of placement, when there are no or few defects present. Such detection methods may be error prone because there is no way to compare any defects detected with prior well casing characterizations. Other time lapse detection methods may be limited in accuracy because of the large time difference between initial characterization and inspection of the well casings.

### BRIEF DESCRIPTION OF THE DRAWINGS

FIG. 1 is a diagram of a wireline system embodiment.

FIG. 2 is a cut-away illustration of downhole incremental pipe characterization during well completion, in accordance with various embodiments.

FIG. 3 illustrates a workflow for pipe and casing inspection in accordance with various embodiments.

FIG. 4 illustrates time-lapse thickness variation in a pipe as can be detected by apparatuses and methods in accordance with various embodiments.

FIG. 5 illustrates an incremental characterization of metal loss using extrapolation in accordance with various embodiments.

FIG. 6 illustrates an example of providing a well treatment to pipes based on predicted metal loss as can be predicted in accordance with various embodiments.

FIG. 7 is a flow diagram illustrating an inversion scheme for incremental characterization of pipes in accordance with various embodiments.

FIG. 8 is a flow diagram illustrating an inversion scheme for obtaining a thickness variation profile based on differences in measurements at two points in time, in accordance with various embodiments.

FIG. 9 is a flow diagram illustrating a method for generating well treatment decisions based on incremental time lapse measurement of pipe properties in accordance with various embodiments.

FIG. 10 is a block diagram of features of an example system operable to execute schemes associated with investigation of multiple nested conductive pipes, in accordance with various embodiments.

FIG. 11 is a diagram of a drilling rig system embodiment.

### DETAILED DESCRIPTION

The following detailed description refers to the accompanying drawings that show, by way of illustration and not limitation, various embodiments that may be practiced. These embodiments are described in sufficient detail to enable those skilled in the art to practice these and other embodiments. Other embodiments may be utilized, and structural, mechanical, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

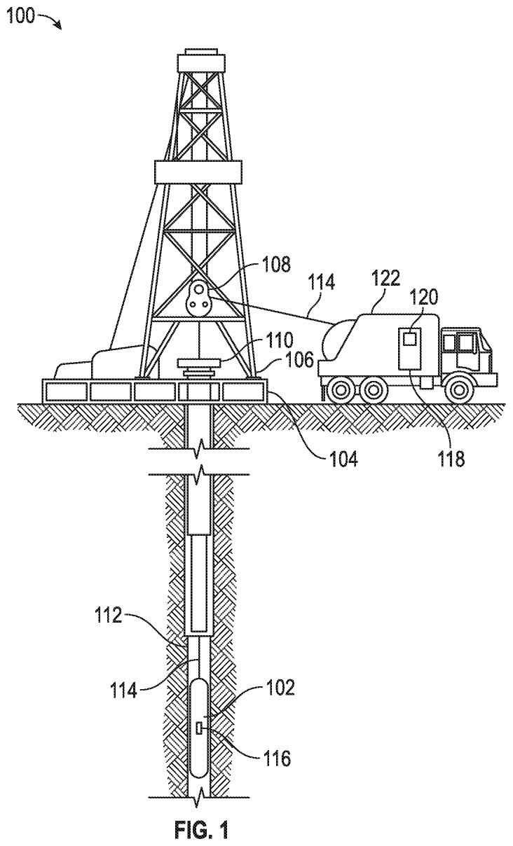

FIG. 1 is a diagram of a wireline system 100 embodiment. The wireline system 100 can comprise portions of a wireline logging tool body 102 as part of a wireline logging operation. Thus, FIG. 1 shows a well during wireline logging operations. In this case, a drilling platform 104 is equipped with a derrick 106 that supports a hoist 108.

Drilling oil and gas wells is commonly carried out using a string of drill pipes connected together so as to form a drilling string that is lowered through a rotary table 110 into a wellbore or borehole 112. Here it is assumed that the drilling string has been temporarily removed from the borehole 112 to allow a wireline logging tool body 102, such as a probe or sonde, to be lowered by wireline or logging cable 114 into the borehole 112. Typically, the wireline logging tool body 102 is lowered to the bottom of the region of interest and subsequently pulled upward at a substantially constant speed. The tool 105 can be disposed in the borehole 106 by a number of different arrangements such as, but not limited to, in a wireline arrangement, a slickline arrangement, a logging-while-drilling (LWD) arrangement or other conveyance arrangement such as coiled tubing, drill pipe, downhole tractor, or the like.

During the upward trip, at a series of depths instruments 116 (e.g., pipe characterization tools such as eddy current (EC) tools described later herein) included in the wireline logging tool body 102 can be used to perform measurements on pipes as well as other measurements subsurface geological formations adjacent the borehole 112 (and the wireline logging tool body 102). The measurement data can be communicated to a surface system 118 for storage, processing, and analysis. The surface system 118 can be provided with electronic equipment for various types of signal processing. Similar formation evaluation data can be gathered and analyzed during drilling operations (e.g., during LWD operations, and by extension, sampling while drilling).

The wireline logging tool body 102 is suspended in the wellbore by a wireline cable 114 that connects the tool to the surface system 118 (which can also include a display 120). This wireline cable 114 can include (or perform functionalities of) a fiber optic cable. The tool can be deployed in the borehole 112 on coiled tubing, jointed drill pipe, hard-wired drill pipe, or any other suitable deployment technique. In embodiments, the fiber optic cable can include sensors for characterize the pipe containing the optical cable and adjacent pipes over time.

Processing of measurement data provided by pipeline characterization tools 116 can be performed to provide total thickness of pipe strings under investigation in real-time. Further, thickness of individual pipes in a nested arrangement can be determined using eddy current processing. Such thickness analysis can be used to inspect the pipes to determining the location and size of defects in the pipes.

Herein, multiple nested conductive pipes are a structure having a set of two or more conductive pipes nested within each other, the set having an innermost pipe and an outermost pipe, where the innermost pipe has the smallest outer diameter of the pipes of the set. The outermost pipe has the largest outer diameter of the pipes of the set. The remaining pipes of the set have outer diameters of value greater than the value of the outer diameter of the innermost pipe and less the than the value of the outer diameter of the outermost pipe with each pipe of the set having a different outer diameter with respect to the other pipes of the set. The multiple nested conductive pipes can be referred to as a conductive multi-pipe structure. In various embodiments, multiple nested conductive pipes can be realized by a set of concentric pipes. However, a multiple nested conductive pipe structure is not limited to a set of concentric pipes. The pipes that comprise the multiple nested conductive pipes can be realized in a number of formats such as, but not limited to, casings and tubings.

According to some pipe defect detection methods, operators can log pipe measurements after pipes have been downhole for long periods (e.g., 20-25 years). According to these approaches, operators obtain the position and percentage metal loss of defects. However, such methods can be error-prone at least because these methods do not provide a mechanism to compare the defects obtained with previous pipe characterizations. Some operators may perform an initial characterization of pipes before placement downhole, for comparison with characterizations after the pipes have been downhole for long periods (e.g., 20-25 years). However, such methods can be error-prone at least because of the large time difference between initial characterization and inspection.

Embodiments described herein address these and other concerns by performing inspection of casings and pipes over time. Methods and apparatuses in accordance with some embodiments can perform an initial characterization of pipes, before pipes are placed downhole, and before pipes have had a chance to experience damage or exhibit defects. These initial characterizations can be compared with other measurements taken over time, after the pipes have been placed in a well completion process. The comparison of measurements from the initial characterization and future inspections can provide better information about the condition of the casings and pipes over time.

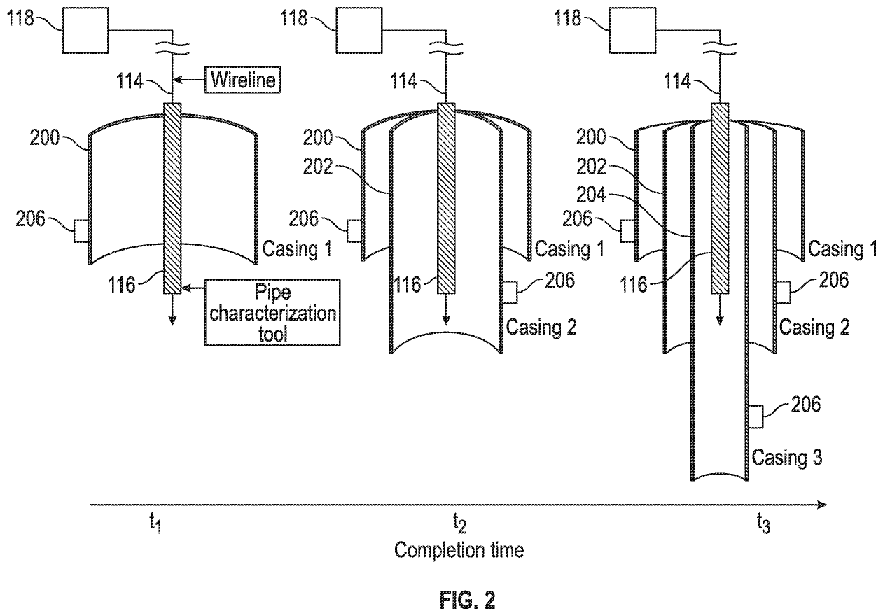

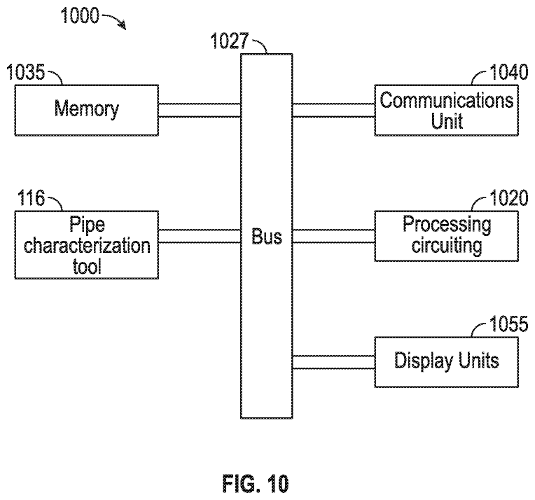

FIG. 2 is a cut-away illustration of downhole incremental pipe characterization during well completion, in accordance with various embodiments. As shown in FIG. 2, pipes can be placed, one after the other, downhole during a well completion process to form a multi-pipe structure. The pipe characterization tool 116 (as part of a pipe characterization system that includes the multiple nested conductive pipes 200, 202, 204 and any processing circuitry (e.g., processing circuitry 1020 (FIG. 10))) can obtain a log every time each pipe 200, 202, 204 is placed. Therefore, each log will have information of the pipe being placed and the previous pipes inside the well. In addition, a set of measurements from different tools can be obtained for each pipe. In this case, the profiles of casings and pipes will contain the effect of temperature, pressure, and the geology of the subsurface.

For example, at time t1, pipe 200 can be placed downhole. The pipe characterization tool 116 can measure characteristics or properties of the pipe 200 at time t1. At time t2, pipe 202 can be placed downhole. As depicted, pipe 202 can be concentric to pipe 200 and pipe 202 can have a smaller radius than pipe 200. The pipe characterization tool 116 can measure characteristics or properties of the pipe 202 at time t2. Additionally or alternatively, the pipe characterization tool 116 can measure properties or characteristics of the pipe 200 at time t2, or properties and characteristics of the multi-pipe structure including pipe 200 and pipe 202. At time t3, pipe 204 can be placed downhole. As depicted, pipe 204 can be concentric to pipe 200 and pipe 202. Pipe 204 can have a smaller radius than pipe 202. The pipe characterization tool 116 can measure characteristics or properties of the pipe 204 at time t3. Additionally or alternatively, the pipe characterization tool 116 can measure properties or characteristics of either or both of pipe 200 and pipe 202 at time t3. Additionally or alternatively, the pipe characterization tool 116 can measure properties and characteristics of the multi-pipe structure including pipe 200, 202 and 204 at time t3 or at any subsequent time.

While three time intervals are shown in FIG. 2, it will be appreciated that the pipe characterization tool 116 can capture data subsequent to time t3 or prior to time t1. While three pipes 200, 202 and 204 are depicted, it will be appreciated that fewer or more than three pipes or casings can be characterized.

Each pipe 200, 202, 204 (and any additional pipes, not shown in FIG. 2) can have an associated profile that includes measurement information, identification information, properties, etc., of a respective pipe. Each pipe 200, 202, 204 can include an associated identification device (e.g., a radio frequency identification (RFID) tag), which can be applied to the pipes 200, 202, 204 before or after placement downhole. Accordingly, a database (e.g., a relational database) can be maintained to record initial and subsequent measurements for pipes 200, 202, 204 based on identification information associated with those pipes.

The pipe characterization tool 116 can be any type of tool capable of providing information about the integrity of pipes (e.g., pipe 200, 202 and 204). As such, the pipe characterization tool 116 can include electromagnetic (EM) tools, acoustic tools or mechanical caliper tools. The information that can be used for pipe characterization includes thickness, metal loss or other characteristic that provide information of defects in the pipe walls. Furthermore, any or all of pipes 200, 202 or 204 can include sensors 206 permanent sensors installed for well monitoring. Sensors 206 can also be used to inspect the respective pipe itself and adjacent pipes over time. As described briefly above, fiber optics can also be used to monitor wells, and the optical fibers can themselves include sensors to characterize pipes. The wireline 114 itself can include fiber optic cables, or a fiber optic cable 208 can be attached to one or more of pipes 200, 202, 204. Sensors placed along the optical fiber can be used to characterize the pipe containing the optical cable and adjacent pipes.

EM tools can be frequency-domain (FD) tools that operate at discrete set of frequencies. Higher frequencies can be used to inspect inner pipes of multiple nested conductive pipes and lower frequencies can be used to inspect outer pipes of the multiple nested conductive pipes. Alternatively, EM tools can operate in time-domain (TD) by transmitting transient pulses and measuring the decay response versus time. Earlier time responses correspond to inner pipes and later time responses correspond to outer pipes. These tools are referred to as pulsed eddy current corrosion detection tools.

EM tools can perform various processing operations on data, and some of these operations are listed in Table 1. However, it will be appreciated that EM tools can perform other operations not listed here.

TABLE 1
Processing operations for EM data.

| Processing | Application |
|---|---|
| Noise reduction | Remove noise on certain frequencies/times |
| (filtering) | |
| Calibration | Adjusting the data with known physical |
| | parameters from other logs |
| Thermal Correction | Correcting the data with known temperature |
| | tables |
| Differential or | The differential or ratio between specific |
| normalization | receivers of the tool can be applied to remove |
| | or emphasize areas of the pipes that are of |
| | interest. Additionally, the differential or ratio |
| | between measurements taken at different |
| | times can emphasize areas of interest. |
| Deconvolution | Improves resolution and reduces shoulder beds |

### Incremental Characterization

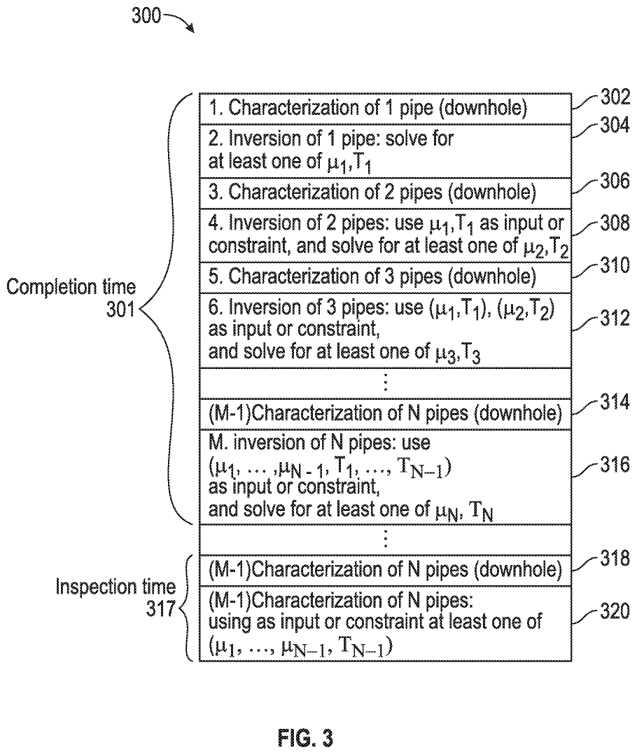

FIG. 3 illustrates a workflow 300 for pipe and casing inspection in accordance with various embodiments. Some of the operations of workflow 300 can be performed by components of the system 100, such as by the pipe characterization tool 116 and the surface system 118.

The example workflow 300 begins with obtaining first measurements of multiple nested conductive pipes 200, 202, 204 (FIG. 2) at a first time (e.g., completion time 301) subsequent to placement of at least one of the multiple nested conductive pipes in a wellbore. During completion time 301, the pipes 200, 202, 204 are characterized, and inverted in sequence to obtain nominal measurements (e.g., nominal thickness) and an EM model of each pipe 200, 202, 204.

For example, in operation 302, the pipe characterization tool 116 can capture measurements that characterize one pipe (e.g., pipe 200). In operation 304, the surface system 118 can perform inversion calculations to solve for at least one of permeability μ₁ and thickness T₁ of that pipe (e.g., pipe 200). In operation 306, the pipe characterization tool 116 can capture measurements that characterize two pipes (e.g., pipe 200 and pipe 202) by performing measurements similar to those shown at time t2 (FIG. 2). In operation 308, the surface system 118 can perform inversion using μ₁ and thickness T₁ as inputs or constraints to solve for permeability μ₂ and thickness T₂ of the second pipe 202. In operation 310, the pipe characterization tool 116 can capture measurements that characterize three pipes (e.g., pipes 200, 202, 204 (FIG. 2)) by performing measurements similar to those shown at time t3 (FIG. 2). In operation 312, the surface system 118 can perform inversion using μ₁, T₁, μ₂ and T₂ as inputs or constraints to solve for permeability μ₃ and thickness T₃ of the third pipe 204. The workflow 300 can continue in a similar manner in operations 314 through 316 to solve for permeability and thickness of any number of pipes.

The example workflow 300 continues with operation 318 by obtaining second measurements of the multiple nested conductive pipes 200, 202, 204 at a second time (e.g., an inspection time 317) subsequent to the first time. During this inspection time 317, the pipes 200, 202, 204 are inspected in operation 318 and the data is inverted in operation 320 using the initial characterization.

Accordingly, in workflow 300, the surface system 118 can calculate a thickness change of the multiple nested conductive pipes 200, 202, 204 between the first time (e.g., the completion time 301) and the second time (e.g., an inspection time 317) to obtain the thickness variation of each pipe 200, 202, 204. While three pipes 200, 202, 204 are described as being characterized and analyzed, any number of pipes can be characterized and the thickness variation of any number of pipes can be determined. During further inspections, the data is inverted either using the initial characterization or the inversion from previous inspection to determine the thickness variations on the pipes 200, 202, 204.

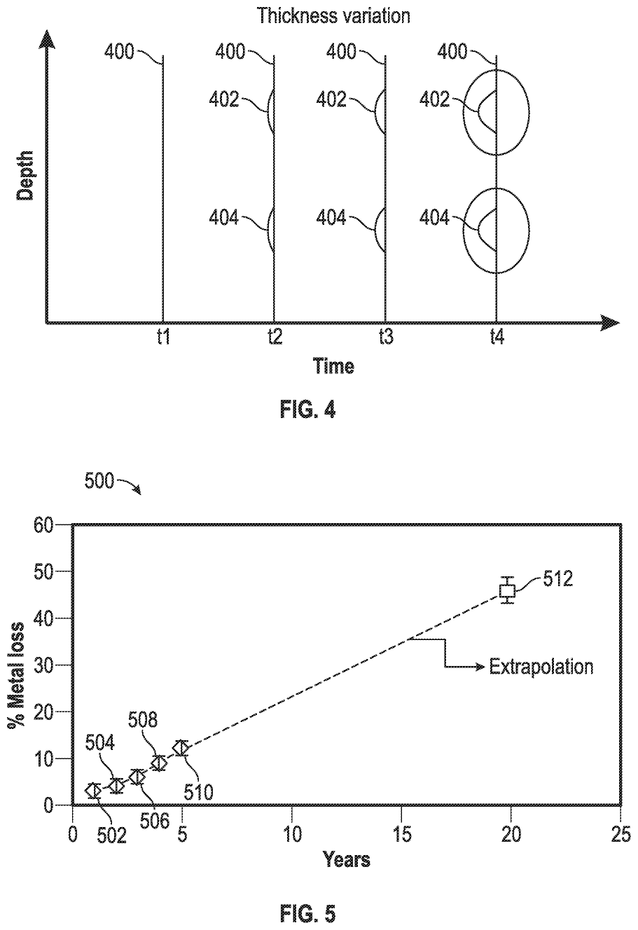

The application of an initial characterization of pipes, and further inspections will give a time-lapse profile of thickness variation for each pipe. The time-lapse profile of thickness variation will provide information of areas vulnerable to defects and the pipes can be replaced or treated in order to prevent or reduce severity of problems downhole. As an example, areas where gradual thickness reductions are observed, and where it is predicted that the reduction would lead to a thickness equal to zero during the lifetime of the well can be identified. These areas may be treated with chemicals that slow down corrosion. They may also be treated with electrical methods that slow down corrosion where deployment of electrodes may be optimized based on known location of the future corrosion problem. FIG. 4 illustrates time-lapse thickness variation in a pipe as can be detected by apparatuses and methods in accordance with various embodiments. While FIG. 4 illustrates time-lapse thickness in one pipe, it will be appreciated that thickness can also vary in any or all of the other pipes of the multiple nested conductive pipes 200, 202, 204.

Referring to time t1, the pipe 400 may exhibit no defects. For example, at time of placement of the pipe 400 in the wellbore, the pipe 400 may have no defects. At time t2, which is subsequent to time t1, pipe 400 may include relatively small defects 400, 402. If defects 400, 402 are deemed to be overly large (e.g., if the defects 400, 402 are larger than predicted), operators can choose to provided well treatments. The detection of defects 400, 402 can also provide information to operators regarding the vulnerable areas (e.g., depths) of the well.

At time t3, defects 400, 402 may become relatively large compared to time t2. This can occur, for example, if no well treatment was provided subsequent to time t2. Similarly, if defects 400, 402 are deemed to be overly large (e.g., if the defects 400, 402 are larger than predicted, or if defects 400, 402 are larger than a threshold level of defect), operators can choose to provided well treatments. At time t4, defects 400, 402 may become relatively large compared to time t3. This can occur, for example, if no well treatment was provided subsequent to time t3. Operators can choose to provided well treatments.

FIG. 5 illustrates an incremental characterization 500 of metal loss using extrapolation in accordance with various embodiments. According to incremental characterization methods of various embodiments, operators can frequently inspect the pipes, for example, every year, as shown in 502, 504, 506, 508, 510. In this type of characterization, the percentage of metal loss can be calculated using the previous year as a baseline. For example, metal loss between measurement 502 and 504 by comparing metal levels at 504 with metal levels at 502. Consequently, the measurement errors are smaller than errors generated by some of the approaches described earlier herein. Furthermore, a prediction of the metal loss over, e.g., 20 years be obtained by extrapolating the measurements trend to that time 512.

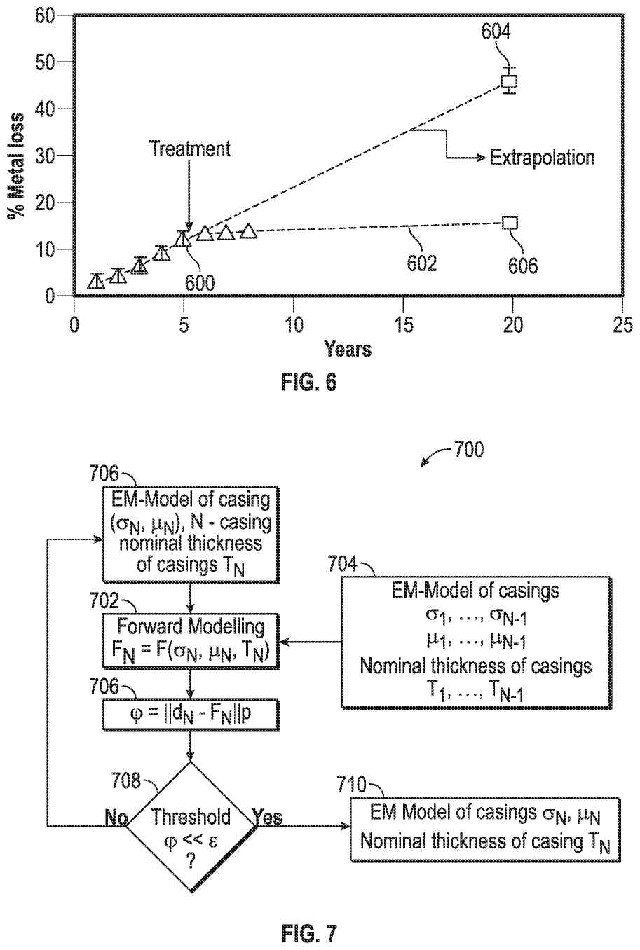

FIG. 6 illustrates an example of providing a well treatment to pipes based on predicted metal loss as can be predicted in accordance with various embodiments. By performing incremental characterization in accordance with various embodiments, operators can make a decision to apply a treatment to the pipes or replace them. As shown in FIG. 6, a treatment is applied to the pipes after 5 years at 600. For example, a certain percentage of metal loss (e.g., 15% metal loss) can be detected for which operators had previously decided well treatment or pipe replacement should be performed. Further measurements after the treatment will produce another trend line 602 and consequently the extrapolated metal loss percentage is reduced at, e.g., year 20. For example, without treatment, metal loss may have been 50% as shown at 604, whereas with treatment at year 5, metal loss may be only 15% as shown at 606. Accordingly, overall metal loss can be reduced by early treatment, improving longevity of wells and reducing operator costs. Applying incremental characterization can improve accuracy of metal loss estimates over time. More accurate model can also be obtained in order to predict pipe status over long periods of time.

### Inversion Schemes for Pipe Characterization

FIG. 7 is a flow diagram illustrating an inversion scheme 700 for incremental characterization of pipes in accordance with various embodiments. In general, the inversion consist of finding values of EM properties and parameters that provides a nearest match between the synthetic response of the model and the measured responses. Methods for pipe characterization of various embodiments perform inversion will find the EM properties of the pipes. Some properties can include permeability μ and thickness T of each pipe over a depth of the wellbore.

The inversion scheme 700 includes forward modeling 702 using a first input 704 that includes the EM model of previously-modeled casings, wherein the EM model includes magnetic permeability (μ), and electrical conductivity (σ) for each given pipe, and nominal thickness T of previously-modeled pipes. A second input 706 includes the EM model (μ_{N}, σ_{N}) and T_{N} of the casing currently being modeled. An error Φ is calculated according to Equation 1:

Φ=∥d_{N}−F_{N}∥ₚ (1)

where d_{N} is data vector, F_{N} is the forward model calculated according to operation 702, and p is the norm, where typically p=2 is used as L2-norm.

If the error Φ is less than a threshold ϵ as determined at operation 708, then the EM model (μ_{N}, σ_{N}) and T_{N} of the pipe N is set in operation 710. Otherwise processing reverts back to operation 706 where new values are chosen for μ_{N}, σ_{N} and T_{N}.

For the initial characterization of single pipes, the inversion procedure is applied to each pipe separately. Therefore, the inversion of a single pipe will not use any information of previous pipe as input, and will obtain the nominal thickness and EM model of each pipe separately.

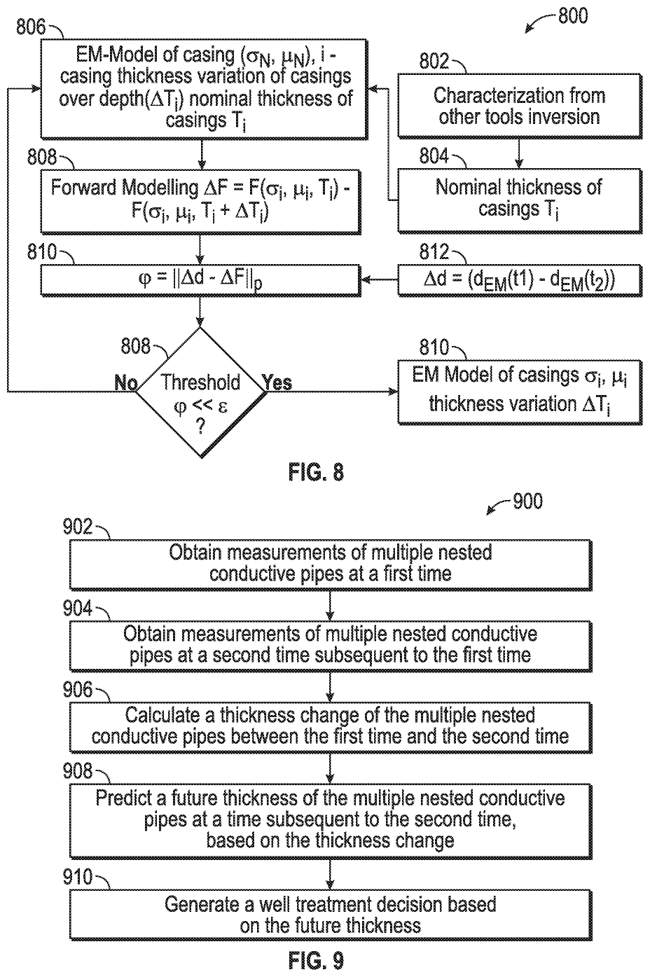

In order to obtain an accurate thickness profile for each pipe, the initial thickness of pipes must be known as well as the signature data for this initial thickness. The initial thickness or nominal thickness of each pipe is obtained during the initial characterization of pipes (completion time). During the inspection time, the inversion is applied by the difference between data measured at different times. FIG. 8 is a flow diagram illustrating an inversion scheme 800 for obtaining a thickness variation profile based on differences in measurements at two points in time (e.g., during inspection time), in accordance with various embodiments.

The inversion scheme 800 takes inputs from a pipe characterization tool (e.g., the pipe characterization tool 116 (FIG. 1)) or of other tools at 802 to generate nominal thickness Tᵢ of casings or pipes at operation 804. The inversion scheme 800 continues with operation 806 by generating an EM model (μᵢ, σᵢ) for each casing. The inversion scheme 800 continues with operation 808 by performing forward modeling using the EM models generated in operation 806, the thickness variations ΔTᵢ and nominal thicknesses Tᵢ.

In operation 810, an error Φ is calculated according to Equation 2:

Φ=∥Δd−ΔF∥ₚ (2)

In FIG. 8, operation 812, the initial time (t₁) corresponds to the initial characterization of the pipes (completion time). The second time (t₂) is any future time when inspection is performed. At operation 812, the inversion scheme 800 obtains the thickness variation profile Δd from the difference of data for two times d_{EM}(t₁) and d_{EM}(t₂) according to Equation (3):

Δd=(d_{EM}(t₁)−d_{EM}(t₂)) (3)

This inversion can be generalized to obtain a time-lapse profile of thickness variation for each pipe, in which case, instead of using the initial characterization for the first time (t1), the data used will be from any previous inspection time. Therefore, the inversion will obtain the changes in thickness ΔTᵢ from one inspection to another. Moreover, data can be jointly inverted with data from different tools.

### Example Methods

FIG. 9 is a flow diagram illustrating an example method 900 for generating well treatment decisions based on incremental time lapse measurement of pipe properties in accordance with various embodiments. Some of the operations of the method 900 can be performed by components of the system 100, such as by the pipe characterization tool 116 and the surface system 118, or by the processing circuitry 1020 (FIG. 10), and based on measurements of pipes 200, 202, 204 (FIG. 2).

The method 900 begins with operation 902 with the pipe characterization tool 116 obtaining first measurements of multiple nested conductive pipes 200, 202, 204 at a first time subsequent to placement of at least one of the multiple nested conductive pipes 200, 202, 204 in a wellbore 112. The pipe characterization tool 116 can provide the measurements to the surface system 118 or the processing circuitry 1020 (FIG. 10).

The method 900 continues with operation 904 with the pipe characterization tool 116 obtaining second measurements of the multiple nested conductive pipes 200, 202, 204 at a second time subsequent to the first time. As described earlier herein, the first time can be during or subsequent to well completion (e.g., 6 months after well completion), and the second time can be any time subsequent to the first time.

Measurements can be taken each time a pipe of the multiple nested conductive pipes 200, 202, 204 is placed to generate a characterization log of the respective pipe being placed and of pipes that were previously placed before the respective pipe. Measurements can include measurements of permeability, electrical conductivity, thickness, metal loss, or other measurements indicative of erosion, or any other property of any fluid, rock, etc., within or adjacent to the wellbore 112.

The pipe characterization tool 116 can provide any measurements to the surface system 118 or to components of the surface system 118. The surface system 118 can then calculate a thickness change of the multiple nested conductive pipes between the first time and the second time (as well as between any other times subsequent to the second time or prior to the first time) in operation 906. The thickness change can be calculated by comparing raw measurement signals obtained by the pipe characterization tool 116 at the first time to raw measurement signals obtained by the pipe characterization tool 116 at the second time to calculate an erosion rate of the multiple nested conductive pipes 200, 202, 204. Alternatively, the thickness change can be calculated by extrapolating, from raw measurement signals obtained at the first time and raw measurement signals obtained at the second time, to generate an extrapolated raw measurement signal that represents properties of the multiple nested conductive pipes 200, 202, 204 at a third time subsequent to the second time. The surface system 118 or processing circuitry 1020 can convert the extrapolated raw measurement signal to a value that represents thickness of the multiple nested conductive pipes 200, 202, 204 at the third time.

Based on this thickness change, the surface system 118 can predict a future thickness of the multiple nested conductive pipes at a time subsequent to the second time in operation 908. In operation 910, the surface system 118 can generate a well treatment decision based on the future thickness.

### Example Apparatuses

FIG. 10 is a block diagram of features of an embodiment of an example system 1100 operable to execute schemes associated with investigation of multiple nested conductive pipes. The system 1100 can be implemented at a well site to, among other things, determine thickness of multiple nested conductive pipes. The system 1100 can also be implemented to determine the thickness of the individual pipes of the multiple nested conductive pipes. Such thickness determination can be used to investigate defects in the multiple nested conductive pipes. The multiple nested conductive pipes can be a production structure of the well site.

The system 1100 can comprise a pipe characterization tool 116. Pipe characterization tool 116 can be realized as an electromagnetic pulsed tool or any other type of tool as described earlier herein.

The pipe characterization tool 116 can be operably disposed in the multiple nested conductive pipes being investigated in a wellbore. The pipe characterization tool 116 can be moved along a longitudinal axis of the pipe characterization tool 116 and/or a longitudinal axis of the multiple nested conductive pipes being investigated using conventional mechanisms of the oil and gas industry, such as but limited to, wireline operations. The pipe characterization tool 116 can be configured to obtain measurements, at multiple sequential times, of the multiple nested conductive pipes subsequent to placement or prior to placement of at least one of the multiple nested conductive pipes in a wellbore. For example, in some embodiments, the pipe characterization tool 116 can obtain first measurements of the multiple nested conductive pipes at a first time subsequent to placement of at least one of the multiple nested conductive pipes in a wellbore. The pipe characterization tool 116 can then obtain second measurements of the multiple nested conductive pipes at a second time subsequent to the first time.

The system 100 can also comprise processing circuitry 1020. The processing circuitry 1020 can be arranged to calculate a thickness change of the multiple nested conductive pipes with respect to any two measurements of thickness. For example, the processing circuitry 1020 can calculate a thickness change of the multiple nested conductive pipes from a first time to a second time to detect metal loss or thickness loss at the second time relative to the first time. Based on this thickness change, the processing circuitry 1020 can predict a future thickness of the multiple nested conductive pipes, and generate a well treatment decision based on the future thickness. In an embodiment, processing circuitry 1020 can be realized as a single processor or a group of processors. Processors of the group of processors can operate independently depending on an assigned function. The processing circuitry 1020 can be realized as one or more application-specific integrated circuits (ASICs). The processing circuitry 1020 can be arranged to determine total thickness of the multiple nested conductive pipes and the thickness of individual pipes of the multiple nested conductive pipes based on the received measurements received from the pipe characterization tool 116 as taught herein.

In controlling operation of the components of system 1000 to execute schemes associated with investigation of multiple nested conductive pipes, the processing circuitry 1020 can direct access of data to and from a database, e.g., a database stored in the memory 1035. The database can include parameters and/or expected parameters for the pipes being investigated such as, but not limited to, diameter (d), magnetic permeability (μ), and electrical conductivity (σ). These parameters can be stored and retrieved using identification information of respective pipes, e.g., RFID tags disposed on respective pipes, using any type or structure of database access command (e.g., Structured Query Language (SQL) commands).

The system 1000 can include a display units 1055 operable with the processing circuitry 1020 to provide information associated with determining thickness in multiple nested conductive pipes as taught herein. The thickness determination can be used to determine defects in pipes of the multiple nested conductive pipe structure. The system 1000 can be arranged to perform various operations on the data, acquired from the pipe characterization tool 116 operational in a multiple nested conductive pipes structure, in a manner similar or identical to any of the processing techniques discussed herein.

The system 1000 can include a communications unit 1040. The processing circuitry 1020 and the communications unit 1040 can be arranged to operate as a processing unit to control management of the pipe characterization tool 116 and to perform operations on data signals collected by the pipe characterization tool 116. The communications unit 1040 can include downhole communications for communication to the surface at a well site from the pipe characterization tool 116 in a multi-pipe structure. The communications unit 1040 can use combinations of wired communication technologies and wireless technologies at frequencies that do not interfere with on-going measurements. The communications unit 1040 can allow for a portion or all of the data analysis to be conducted within a multiple nested conductive pipes structure with results provided to the display units 1055 for presentation on the one or more display unit(s) 1055 aboveground. The communications unit 1040 can provide for data to be sent aboveground such that substantially all analysis is performed aboveground. The data collected by the pipe characterization tool 116 can be stored with the pipe characterization tool 116 that can be brought to the surface to provide the data to the processing circuitry 1020 and the display unit 1055. The communications unit 1040 can allow for transmission of commands to pipe characterization tool 116 in response to signals provided by a user. Such commands can be generated from autonomous operation of the system 1000, once initiated.

The system 1000 can also include a bus 1027, where the bus 1027 provides electrical conductivity among the components of the system 1000. The bus 1027 can include an address bus, a data bus, and a control bus, each independently configured. The bus 1027 can be realized using a number of different communication mediums that allows for the distribution of components of the system 1000. Use of the bus 1027 can be regulated by the processing circuitry 1020. The bus 1027 can include a communications network to transmit and receive signals including data signals and command and control signals.

The display unit(s) 1055 can be arranged with a screen display, as a distributed component on the surface with respect to a well site, that can be used with instructions stored in the memory module 1035 to manage the operation of the pipe characterization tool 116 and/or components distributed within the system 1000. Such a user interface can be operated in conjunction with the communications unit 1040 and the bus 1027. The display unit(s) 1055 can include a video screen, a printing device, or other structure to visually project data/information and images.

In various embodiments, a non-transitory machine-readable storage device can comprise instructions stored thereon, which, when performed by a machine, cause the machine to perform operations, the operations comprising one or more features similar to or identical to features of methods and techniques described with respect to method 900, variations thereof, and/or features of other methods taught herein such as associated with FIGS. 1-9. The physical structures of such instructions may be operated on by one or more processors (e.g., processing circuitry 1020). Executing these physical structures can cause the machine to perform operations comprising: making a first set of log measurements, at a first time, using a pipe characterization tool disposed in multiple nested conductive pipes in a wellbore; determining total thickness of the multiple nested conductive pipes at the first time; and making a second set of log measurements, at a second time, using the pipe characterization tool disposed in the multiple nested conductive pipes. Execution of various instructions may be realized by the control circuitry of the machine. The instructions can include instructions to operate a tool or tools having sensors disposed in multiple nested conductive pipes in a wellbore to provide data to process in accordance with the teachings herein. The multiple nested conductive pipes may be realized as a multi-pipe structure disposed in a wellbore at a well site. Such machine-readable storage devices can include instructions to use an electromagnetic pulsed tool.

The operations can include estimating thickness of individual pipes of the multiple nested conductive pipes, wherein estimating thickness of individual pipes of the multiple nested conductive pipes includes estimating the thickness of the individual pipes sequentially, starting from the innermost pipe. The operations can further include directing remedial operations with respect to the multiple nested conductive pipes in response to determining the total thickness of the multiple nested conductive pipes or estimating the thickness of individual pipes of the multiple nested conductive pipes.

Further, a machine-readable storage device, herein, is a physical device that stores data represented by physical structure within the device. Such a physical device is a non-transitory device. Examples of machine-readable storage devices can include, but are not limited to, read only memory (ROM), random access memory (RAM), a magnetic disk storage device, an optical storage device, a flash memory, and other electronic, magnetic, and/or optical memory devices. The machine-readable device may be a machine-readable medium such as memory module 1035. While memory module 1035 is shown as a single unit, terms such as “memory module,” “machine-readable medium,” “machine-readable device,” and similar terms should be taken to include all forms of storage media, either in the form of a single medium (or device) or multiple media (or devices), in all forms. For example, such structures can be realized as centralized database(s), distributed database(s), associated caches, and servers; one or more storage devices, such as storage drives (including but not limited to electronic, magnetic, and optical drives and storage mechanisms), and one or more instances of memory devices or modules (whether main memory; cache storage, either internal or external to a processor; or buffers). Terms such as “memory module,” “machine-readable medium,” “machine-readable device,” shall be taken to include any tangible non-transitory medium which is capable of storing or encoding a sequence of instructions for execution by the machine and that cause the machine to perform any one of the methodologies taught herein. The term “non-transitory” used in reference to a “ machine-readable device,” “medium,” “storage medium,” “device,” or “storage device” expressly includes all forms of storage drives (optical, magnetic, electrical, etc.) and all forms of memory devices (e.g., DRAM, Flash (of all storage designs), SRAM, MRAM, phase change, etc., as well as all other structures designed to store data of any type for later retrieval.

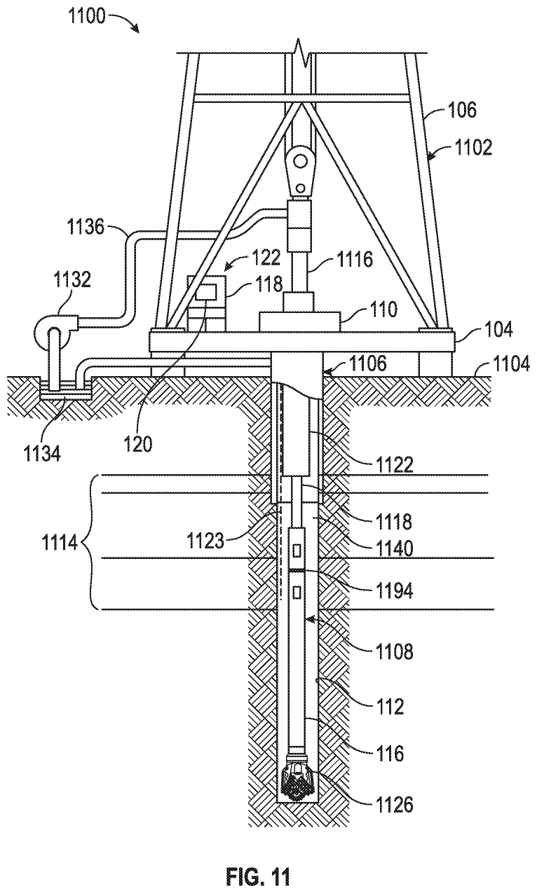

In addition to wireline embodiments, example embodiments can also be implemented in drilling rig systems. FIG. 11 illustrates a drilling rig system 1100 embodiment. The system 1100 can include a pipe characterization tool 116 as part of a downhole drilling operation (e.g., during a logging while drilling (LWD) operation).

Referring to FIG. 11, it can be seen how a system 1100 can also form a portion of a drilling rig 1102 located at the surface 1104 of a well 1106. The drilling rig 1102 can provide support for a drill string 1108. The drill string 1108 can operate to penetrate the rotary table 110 for drilling the borehole 112 through the subsurface formations 1114. The drill string 1108 can include a Kelly 1116, drill pipe 1118, and a bottom hole assembly, perhaps located at the lower portion of the drill pipe 1118.

The bottom hole assembly can include drill collars 1122, a downhole tool 116, and a drill bit 1126. The drill bit 1126 can operate to create the borehole 112 by penetrating the surface 1104 and the subsurface formations 115. The downhole tool 116 can comprise any of a number of different types of tools including pipe characterization tools, MWD tools, LWD took, and others. In some examples, fiber optic cable 1123 will be spliced, rerouted, coupled, guided, or otherwise modified to maintain connections at each drill collar 1122 and at each position along the drill string 1108. In some embodiments, a fiber optic connector can be provided at each drill collar 1122 or other joint or position downhole.

During drilling operations, the drill string 1108 (perhaps including the Kelly 1116, the drill pipe 1118, and the bottom hole assembly) can be rotated by the rotary table 110. Although not shown, in addition to, or alternatively, the bottom hole assembly 1020 can also be rotated by a motor (e.g., a mud motor) that is located downhole. The drill collars 1122 can be used to add weight to the drill bit 1126. The drill collars 1122 can also operate to stiffen the bottom hole assembly, allowing the bottom hole assembly to transfer the added weight to the drill bit 1126, and in turn, to assist the drill bit 1126 in penetrating the surface 1104 and subsurface formations 1114.

During drilling operations, a mud pump 1132 may pump drilling fluid (sometimes known by those of ordinary skill in the art as “drilling mud”) from a mud pit 1134 through a hose 1136 into the drill pipe 1118 and down to the drill bit 1126. The drilling fluid can flow out from the drill bit 1126 and be returned to the surface 1104 through an annular area 1140 between the drill pipe 1118 and the sides of the borehole 112. The drilling fluid may then be returned to the mud pit 1134, where such fluid is filtered. In some embodiments, the drilling fluid can be used to cool the drill bit 1126, as well as to provide lubrication for the drill bit 1126 during drilling operations. Additionally, the drilling fluid may be used to remove subsurface formation cuttings created by operating the drill bit 1126.

Thus, it can be seen that in some embodiments, the systems 100, 1100 can include a drill collar 1122, a downhole tool 1124, and/or a wireline logging tool body 102 to house one or more downhole units, similar to or identical to the pipe characterization tool 116.

Thus, for the purposes of this document, the term “housing” when used to address tools below the surface (e.g., downhole), can include any one or more of a drill collar 1122, a downhole tool 1124, or a wireline logging tool body 102 (all having an outer wall, to enclose or attach to magnetometers, sensors, fluid sampling devices, pressure measurement devices, transmitters, receivers, acquisition and processing logic, and data acquisition systems). The tool 1124 can comprise a downhole tool, such as an LWD tool or MWD tool. The wireline logging tool body 102 can comprise a wireline logging tool, including a probe or sonde, for example, coupled to a logging cable 114. Many embodiments can thus be realized.

Thus, a system 100, 1100 can comprise a downhole tool body, such as a wireline logging tool body 102 or a downhole tool 1124 (e.g., an LWD or MWD tool body), and fiber optic cable 104 to provide signaling to the surface system 118.

The physical structure of such instructions can be operated on by one or more processors. Executing instructions determined by these physical structures can cause the optical detection system 100 or components thereof to perform operations according to methods described herein. The instructions can include instructions to cause associated data or other data to be stored in a memory.

The wireline logging tool body 102 (FIG. 1) can include or otherwise be utilized in conjunction with any number of measurement tools such as resistivity tools, seismic tools, acoustic tools, temperature sensors, porosity sensors and others. In one embodiment, the wireline logging tool body 102 is equipped with transmission equipment to communicate ultimately to a surface processing unit of a surface system 118 (FIG. 1). Such transmission equipment can take any desired form, and different transmission media and methods can be used. Examples of connections include wired, fiber optic, wireless connections and memory based systems.

Various techniques as taught herein can provide initial characterization of pipes, casings, etc., inside the wellbore in order to provide more realistic and improved analysis of the state of pipes and casings after these pipes and casings have been in place downhole for many months or years. In addition, the time-lapse profiling using incremental characterization of pipes to detect areas prone to defects can allow for timely application of well treatments and preventative measures.

The following are example embodiments of methods, machine-readable storage devices, and systems in accordance with the teachings herein.

Example 1 is a method comprising: obtaining first measurements of multiple nested conductive pipes at a first time subsequent to placement of at least one of the multiple nested conductive pipes in a wellbore; obtaining second measurements of the multiple nested conductive pipes at a second time subsequent to the first time; calculating a thickness change of the multiple nested conductive pipes between the first time and the second time; predicting a future thickness of the multiple nested conductive pipes at a time subsequent to the second time, based on the thickness change; and generating a well treatment decision based on the future thickness.

In Example 2, the subject matter of Example 1 can optionally include wherein calculating the thickness change includes comparing raw measurement signals obtained at the first time to raw measurement signals obtained at the second time to calculate an erosion rate of the multiple nested conductive pipes.

In Example 3, the subject matter of any of Examples 1-2 can optionally include extrapolating, from raw measurement signals obtained at the first time and raw measurement signals obtained at the second time, to generate an extrapolated raw measurement signal that represents properties of the multiple nested conductive pipes at a third time subsequent to the second time; and converting the extrapolated raw measurement signal to a value that represents thickness of the multiple nested conductive pipes at the third time.

In Example 4, the subject matter of Example 1 can optionally include wherein the measurements include thickness.

In Example 5, the subject matter of Example 1 can optionally include wherein the measurements include metal loss.

In Example 6, the subject matter of Example 1 can optionally include wherein measurements are taken each time a pipe of the multiple nested conductive pipes is placed to generate a characterization log of the respective pipe being placed and of pipes that were previously placed before the respective pipe.

In Example 7, the subject matter of Example 6 can optionally comprise obtaining nominal measurements of each pipe as the respective pipe is placed in the wellbore.

In Example 8, the subject matter of Example 7 can optionally include wherein obtaining nominal measurements includes: performing inversion to calculate at least one of permeability and thickness of each pipe as the respective pipe is placed in the wellbore, prior to the first time.

In Example 9, the subject matter of Example 8 can optionally include providing an input of at least one of permeability and thickness of a first pipe of the multiple nested conductive pipes placed in the wellbore to an inversion calculation corresponding to a subsequently placed pipe of the multiple nested conductive pipes.

Example 10 is a system (e.g., a pipe system, pipe characterization system, or other detection system) comprising: multiple nested conductive pipes; a pipe characterization tool disposed in the multiple nested conductive pipes and configured to: obtain first measurements of the multiple nested conductive pipes at a first time subsequent to placement of at least one of the multiple nested conductive pipes in a wellbore; and obtain second measurements of the multiple nested conductive pipes at a second time subsequent to the first time; and processing circuitry to: calculate a thickness change of the multiple nested conductive pipes between the first time and the second time; predict a future thickness of the multiple nested conductive pipes at a time subsequent to the second time, based on the thickness change; and generate a well treatment decision based on the future thickness.

In Example 11, the subject matter of Example 10 can optionally include wherein at least one pipe of the multiple nested conductive pipes include sensors for well monitoring.

In Example 12, the subject matter of Example 11 can optionally include wherein the sensors are placed on fiber optic cable on at least one pipe of the multiple nested conductive pipes.

In Example 13, the subject matter of any of Examples 10-12 can optionally include wherein each pipe of the multiple nested conductive pipes includes an associated radio frequency identification (RFID) tag and wherein the system further includes memory to store measurements of a pipe corresponding to each respective RFID tag.

In Example 14, the subject matter of any of Examples 10-13 can optionally include wherein the pipe characterization tool includes an electromagnetic (EM) tool.

In Example 15, the subject matter of any of Examples 10-14 can optionally include wherein the pipe characterization tool includes an acoustic tool.

In Example 16, the subject matter of any of Examples 10-15 can optionally include wherein the pipe characterization tool includes a mechanical caliper tool.

Example 17 includes a machine-readable storage device having instructions (e.g., software, firmware, etc.) stored thereon, which, when executed by a machine, cause the machine to perform operations, the operations comprising: making a first set of log measurements, at a first time, using a pipe characterization tool disposed in multiple nested conductive pipes in a wellbore; determining total thickness of the multiple nested conductive pipes at the first time; and making a second set of log measurements, at a second time, using the pipe characterization tool disposed in the multiple nested conductive pipes.

In Example 18, the subject matter of Example 17 can optionally include wherein the operations include estimating thickness of individual pipes of the multiple nested conductive pipes.

In Example 19, the subject matter of Example 18 can optionally include wherein estimating thickness of individual pipes of the multiple nested conductive pipes includes estimating the thickness of individual pipes sequentially, starting from an innermost pipe.

In Example 20, the subject matter of Example 18 can optionally include wherein the operations include directing remedial operations with respect to the multiple nested conductive pipes in response to determining the total thickness of the multiple nested conductive pipes or estimating the thickness of individual pipes of the multiple nested conductive pipes.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description. Combinations of the above embodiments and other embodiments will be apparent to those of skill in the art upon studying the above description.

What is claimed is:

1. A method comprising:
obtaining first measurements of multiple nested conductive pipes at a first time subsequent to placement of at least one of the multiple nested conductive pipes in a wellbore;
obtaining second measurements of the multiple nested conductive pipes at a second time subsequent to the first time;
calculating a thickness change of the multiple nested conductive pipes between the first time and the second time;
predicting a future thickness of the multiple nested conductive pipes at a time subsequent to the second time, based on the thickness change; and
generating a well treatment decision based on the future thickness.

2. The method of claim 1, wherein calculating the thickness change includes comparing raw measurement signals obtained at the first time to raw measurement signals obtained at the second time to calculate an erosion rate of the multiple nested conductive pipes.

3. The method of claim 1, further comprising:
extrapolating, from raw measurement signals obtained at the first time and raw measurement signals obtained at the second time, to generate an extrapolated raw measurement signal that represents properties of the multiple nested conductive pipes at a third time subsequent to the second time; and
converting the extrapolated raw measurement signal to a value that represents thickness of the multiple nested conductive pipes at the third time.

4. The method of claim 1, wherein the measurements include thickness.

5. The method of claim 1, wherein the measurements include metal loss.

6. The method of claim 1, wherein measurements are taken each time a pipe of the multiple nested conductive pipes is placed to generate a characterization log of the respective pipe being placed and of pipes that were previously placed before the respective pipe.

7. The method of claim 6, further comprising obtaining nominal measurements of each pipe as the respective pipe is placed in the wellbore.

8. The method of claim 7, wherein obtaining nominal measurements includes:
performing inversion to calculate at least one of permeability and thickness of each pipe as the respective pipe is placed in the wellbore, prior to the first time.

9. The method of claim 8, further comprising:
providing an input of at least one of permeability and thickness of a first pipe of the multiple nested conductive pipes placed in the wellbore to an inversion calculation corresponding to a subsequently placed pipe of the multiple nested conductive pipes.

10. A pipe characterization system comprising:
multiple nested conductive pipes;
a pipe characterization tool disposed in the multiple nested conductive pipes and configured to:
obtain first measurements of the multiple nested conductive pipes at a first time subsequent to placement of at least one of the multiple nested conductive pipes in a wellbore; and
obtain second measurements of the multiple nested conductive pipes at a second time subsequent to the first time; and
processing circuitry to:
calculate a thickness change of the multiple nested conductive pipes between the first time and the second time;
predict a future thickness of the multiple nested conductive pipes at a time subsequent to the second time, based on the thickness change; and
generate a well treatment decision based on the future thickness.

11. The pipe characterization system of claim 10, wherein at least one pipe of the multiple nested conductive pipes include sensors for well monitoring.

12. The pipe characterization system of claim 11, wherein the sensors are placed on fiber optic cable on at least one pipe of the multiple nested conductive pipes.

13. The pipe characterization system of claim 10, wherein each pipe of the multiple nested conductive pipes includes an associated radio frequency identification (RFID) tag and wherein the system further includes memory to store measurements of a pipe corresponding to each respective RFID tag.

14. The pipe characterization system of claim 10, wherein the pipe characterization tool includes an electromagnetic (EM) tool.

15. The pipe characterization system of claim 10, wherein the pipe characterization tool includes an acoustic tool.

16. The pipe characterization system of claim 10, wherein the pipe characterization tool includes a mechanical caliper tool.

17. A machine-readable storage device having instructions stored thereon, which, when executed by a machine, cause the machine to perform operations, the operations comprising:
making a first set of log measurements, at a first time, using a pipe characterization tool disposed in multiple nested conductive pipes in a wellbore;
determining total thickness of the multiple nested conductive pipes at the first time; and
making a second set of log measurements, at a second time, using the pipe characterization tool disposed in the multiple nested conductive pipes.

18. The machine-readable storage device of claim 17, wherein the operations include estimating thickness of individual pipes of the multiple nested conductive pipes.

19. The machine-readable storage device of claim 18, wherein estimating thickness of individual pipes of the multiple nested conductive pipes includes estimating the thickness of individual pipes sequentially, starting from an innermost pipe.

20. The machine-readable storage device of claim 18, wherein the operations include directing remedial operations with respect to the multiple nested conductive pipes in response to determining the total thickness of the multiple nested conductive pipes or estimating the thickness of individual pipes of the multiple nested conductive pipes.
